(19) United States
(12) Patent Application Publication
(10) Pub. No.: US 2008/0235500 A1
(43) Pub. Date: Sep. 25, 2008

(54) STRUCTURE FOR INSTRUCTION CACHE TRACE FORMATION

(76) Inventors: GORDON T. DAVIS, Chapel Hill, NC (US); Richard W. Doing, Raleigh, NC (US); John D. Jabusch, Cary, NC (US); M. V.V. Anil Krishna, Cary, NC (US); Brett Olsson, Cary, NC (US); Eric F. Robinson, Raleigh, NC (US); Sumedh W. Sathaye, Austin, TX (US); Jeffrey R. Summers, Raleigh, NC (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 12/131,442

(22) Filed: Jun. 2, 2008

Related U.S. Application Data
(63) Continuation-in-part of application No. 11/561,908, filed on Nov. 21, 2006.

(51) Int. Cl. G06F 9/30

(52) U.S. Cl. 712/239; 712/E09.016

(57) ABSTRACT

A design structure embodied in a machine readable storage medium for at least one of designing, manufacturing, and testing a design for a single unified level one instruction cache in which some lines may contain traces and other lines in the same congruence class may contain blocks of instructions consistent with conventional cache lines is provided. Instruction branches are predicted taken or not taken using a highly accurate branch history table (BHT). Branches that are predicted not taken are appended to a trace buffer and the next basic block is constructed from the remaining instructions in the fetch buffer. Branches that are predicted taken flush the remaining fetch buffer and the next address is determined using a Branch Target Address Register (BTAC).

### CROSS-REFERENCE TO RELATED APPLICATION

This application is a continuation-in-part of co-pending U.S. patent application Ser. No. 11/561,908, filed Nov. 21, 2006, which is herein incorporated by reference.

### BACKGROUND OF INVENTION

### Field of Invention

This invention generally relates to design structures, and more specifically, design structures for managing caches in a processing system.

Traditional processor designs make use of various cache structures to store local copies of instructions and data in order to avoid lengthy access times of typical DRAM memory. In a typical cache hierarchy, caches closer to the processor (level one or L1) tend to be smaller and very fast, while caches closer to the DRAM (L2 or L3) tend to be significantly larger but also slower (longer access time). The larger caches tend to handle both instructions and data, while quite often a processor system will include separate data cache and instruction cache at the L1 level (i.e. closest to the processor core). All of these caches typically have similar organization, with the main difference being in specific dimensions (e.g. cache line size, number of ways per congruence class, number of congruence classes).

In the case of an L1 Instruction cache, the cache is accessed either when code execution reaches the end of the previously fetched cache line or when a taken (or at least predicted taken) branch is encountered within the previously fetched cache line. In either case, a next instruction address is presented to the cache. In typical operation, a congruence class is selected via an abbreviated address (ignoring high-order bits), and a specific way within the congruence class is selected by matching the address to the contents of an address field within the tag of each way within the congruence class. Addresses used for indexing and for matching tags can use either effective or real addresses depending on system issues beyond the scope of this discussion. Typically, low order address bits (e.g. selecting specific byte or word within a cache line) are ignored for both indexing into the tag array and for comparing tag contents. This is because for conventional caches, all such bytes/words will be stored in the same cache line.

Recently, Instruction Caches that store traces of instruction execution have been used, most notably with the Intel Pentium 4. These “Trace Caches” typically combine blocks of instructions from different address regions (i.e. that would have required multiple conventional cache lines). The objective of a trace cache is to handle branching more efficiently, at least when the branching is well predicted. The instruction at a branch target address is simply the next instruction in the trace line, allowing the processor to execute code with high branch density just as efficiently as it executes long blocks of code without branches. Just as parts of several conventional cache lines may make up a single trace line, several trace lines may contain parts of the same conventional cache line. Because of this, the tags must be handled differently in a trace cache.

In a conventional cache, low-order address lines are ignored, but for a trace line, the full address must be used in the tag. A related difference is in handling the index into the cache line. For conventional cache lines, the least significant bits are ignored in selecting a cache line (both index & tag compare), but in the case of a branch into a new cache line, those least significant bits are used to determine an offset from the beginning of the cache line for fetching the first instruction at the branch target. In contrast, the address of the branch target will be the first instruction in a trace line. Thus no offset is needed. Flow-through from the end of the previous cache line via sequential instruction execution simply uses an offset of zero since it will execute the first instruction in the next cache line (independent of whether it is a trace line or not). The full tag compare will select the appropriate line from the congruence class. In the case where the desired branch target address is within a trace line but not the first instruction in the trace line, the trace cache will declare a miss, and potentially construct a new trace line starting at that branch target.

For a trace cache design to function correctly and with a high level of performance, the trace formation methodology is critical to the design. Trace formation involves fetching instructions from a higher level memory, identifying and predicting all branches in the stream, creating a “basic block” of instructions from this and appending it to the current instruction trace. A basic block is defined as all instructions up to and including the first branch in an instruction stream.

### SUMMARY OF THE INVENTION

This invention contemplates that branches are predicted taken or not taken using a highly accurate branch history table (BHT). Branches that are predicted not taken are appended to a trace buffer and the next basic block is constructed from the remaining instructions in the fetch buffer. Branches that are predicted taken flush the remaining fetch buffer and the next address is determined using a Branch Target Address Register (BTAC). This address is used to fetch the next instruction stream that will be used to build the next basic block. Multiple basic blocks are typically added to the same trace line, within the constraints of trace termination rules to be described below.

In one embodiment, a design structure embodied in a machine readable storage medium for at least one of designing, manufacturing, and testing a design is provided. The design structure generally includes an apparatus, which includes a computer system central processor, layered memory operatively coupled to said central processor and accessible thereby, said layered memory having a level one cache storing in interchangeable locations both conventional cache lines of sequential instructions and trace cache lines of predicted branch instructions, and circuitry operatively connected to said layered memory and generating data to be stored in said level one cache, said circuitry distinguishing between conventional cache lines and trace cache lines.

### BRIEF DESCRIPTION OF THE DRAWINGS

Some of the purposes of the invention having been stated, others will appear as the description proceeds, when taken in connection with the accompanying drawings, in which:

FIG. 1 is a schematic representation of the operative coupling of a computer system central processor and layered memory which has level 1, level 2 and level 3 caches and DRAM;

FIG. 2 is a schematic representation of the organization of a L1 instruction cache;

FIG. 3 is a schematic representation of the instruction flow in generating a trace in accordance with this invention;

FIG. 4 is a schematic representation of the address flow in generating a trace in accordance with this invention; and

FIG. 5 is a flow diagram representing procedures involved in generating a trace for an instruction “A” that then branches to an instruction “B”.

FIG. 6 is a flow diagram of a design process used in semiconductor design, manufacture, and/or test.

### DETAILED DESCRIPTION OF THE INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

The term “programmed method”, as used herein, is defined to mean one or more process steps that are presently performed; or, alternatively, one or more process steps that are enabled to be performed at a future point in time. The term programmed method contemplates three alternative forms. First, a programmed method comprises presently performed process steps. Second, a programmed method comprises a computer-readable medium embodying computer instructions which, when executed by a computer system, perform one or more process steps. Third, a programmed method comprises a computer system that has been programmed by software, hardware, firmware, or any combination thereof to perform one or more process steps. It is to be understood that the term programmed method is not to be construed as simultaneously having more than one alternative form, but rather is to be construed in the truest sense of an alternative form wherein, at any given point in time, only one of the plurality of alternative forms is present.

Instruction traces are created by appending basic blocks into the trace formation register. Various rules (stated below) have been defined for forming and ending traces. The purpose of the rules is to form traces that maximize performance while maintaining functionality. Once a trace has been formed, it is written into the trace cache where it can then be accessed for execution.

The present invention contemplates a method in which a cache runs in normal cache mode and then receives traces generated once branch prediction has “warmed up”. The address of the next trace line is stored at the end of the trace. Branch prediction is not required at the output of the cache, which saves logic/cycles by not having to re-predict the address. Only the address of the first basic block in a trace line is needed to access all basic blocks in the trace. Translation information is implicit within a traceline. Termination of a trace line occurs when the next basic block is taken from a page with different memory attributes than other basic blocks in the trace entry.

Termination of a trace line currently under construction occurs in a number of defined circumstances when: (1) a data dependent branch is encountered; (2) a bdnz instruction is encountered; (3) a branch with negative displacement is encountered; (4) a weakly predicted branch is encountered; (5) too many basic blocks are encountered; and (6) a basic block ends close to the end of a trace line.

New trace generation is initiated when a Trace Cache Miss occurs or when a conventional cache line is found in the cache and there is reason to believe that branch prediction is better now than when the line was placed in the cache. The address of the miss (or hit on conventional line) is used to fetch the next group of instructions from higher level memory (second level cache). This address is also used to access the “branch target address cache” (BTAC) which provides the next expected address that needs to be fetched. This next address will be the target of a branch from the first group of instructions or the next sequential address. Either way, this address is first used to access the trace cache and if another miss occurs then it is also sent to the second level cache and is considered a prefetch (i.e. predicted address).

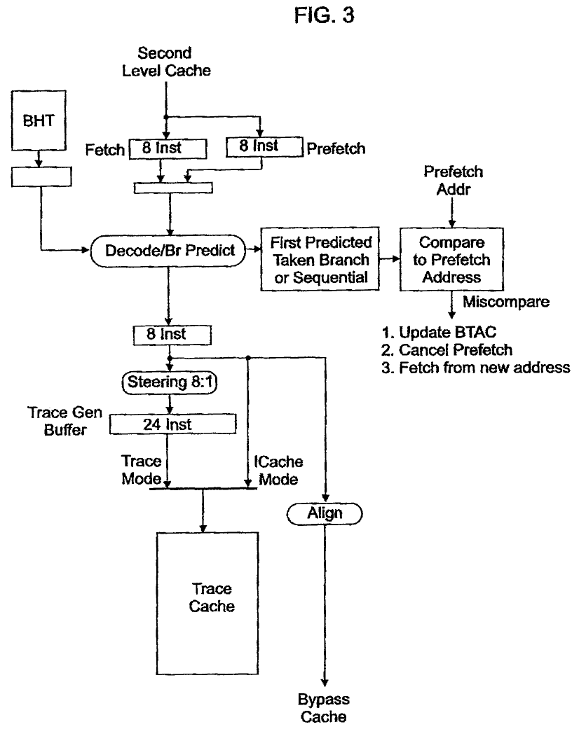

Once instructions are returned from the second level cache they are placed in the instruction fetch register (FIG. 3). The instructions are then decoded and branch prediction is applied to any of the 8 instructions that are branches. The first predicted taken branch is identified and its' address determined. This address is compared to the prefetch address that was sent to the second level cache. If the addresses are not the same, the prefetch is canceled, the correct address is sent to the second level cache and the BTAC is updated with the correct address. If the prefetch address is correct then the prefetch becomes a fetch and a new prefetch is initiated using the BTAC.

A “basic block” of instructions is next formed starting with the 8 instructions from instruction fetch and may continue with additional sequential instruction fetches of 8 instruction blocks until the end of that basic block is detected. The basic block includes the first and subsequent instructions up to the first branch instruction. If there are no branches then the basic block contains all 8 instructions and the next address would be the sequential address (next address after last instruction). The basic block is added to the trace formation buffer by appending to the end of an existing trace or is used to begin a new trace.

Once the basic block is moved to the trace buffer, the next set of instructions (fetch or prefetch) are handled in the same way by predicting branches, decoding and using the BTAC to request the next set of instructions.

Once the trace buffer has been filled with basic blocks (see rules below for determining when full) then the trace line is written into the cache.

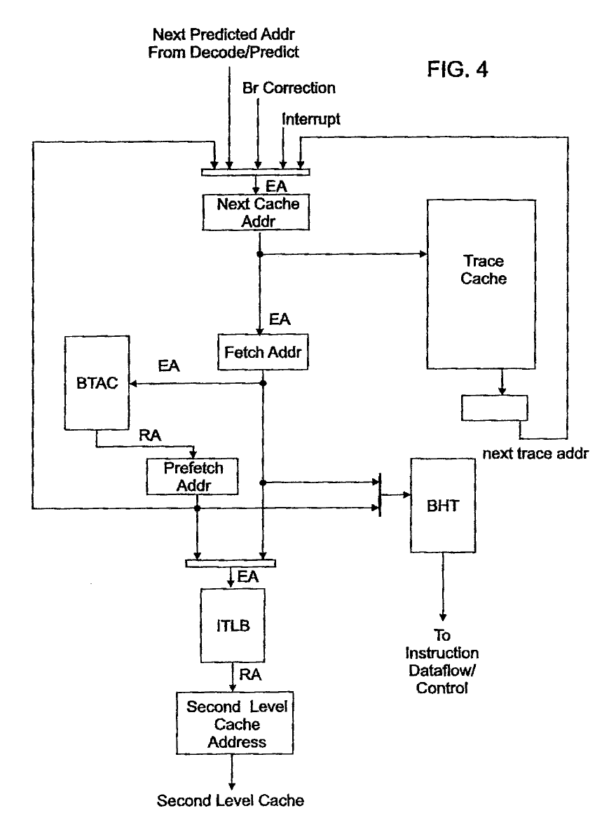

The address of the next instruction (after the last basic block) is also stored in the cache along with the trace line. This address is determined in the normal way of branch prediction/BTAC look-up while determining basic blocks. When the trace line is accessed from the cache, the next trace is known without going through the branch prediction logic. Address flow is represented in FIG. 4.

This trace cache is capable of storing trace lines or normal cache lines (instructions in sequential order). Also, for performance reasons, all instructions arriving from the second level cache can be bypassed around the trace cache and dispatched as normal cache lines. Therefore, while building trace lines the instructions are sent onto the dispatch/execute engines to maintain forward progress while generating traces. Trace generation can be terminated whenever it has been determined that the line being built is no longer good for function or performance. A series of rules have been developed for forming traces.

The set of basic rules governing the building of trace lines (trace generation terminates and a trace is placed in the cache) is listed hereinafter. A system in accordance with this invention may implement one, all or a subset of these rules:
1. Trace lines have a maximum of N instructions (where N may be 16, 24, 32 or some other convenient length). This constraint is due to the physical length of each line in the cache. A basic block that exceeds N instructions in the trace buffer ends the formation of the current trace line. Remaining instructions in the current basic block will be used to start formation of a subsequent trace line.
2. At the end of a basic block, if the trace is filled within L instructions (where L may be 5 or some other convenient length) from the end of the trace buffer, the construction of the trace line will be terminated, and that line is placed in the cache (since it is likely that the next basic block will overflow). This makes traces more useful during subsequent phases of program execution since it potentially avoids a branch within the trace that could end up going in the opposite direction.
3. Traces are terminated on data-dependent branch targets (branch to link, branch to count) since the branch-to address is not accurately predictable.
4. Terminate a trace on a bdnz (and similar type) instruction. These instructions are typically used to form loops, and by terminating a trace at a bdnz, duplication of instructions within the loop is typically avoided.
5. Branches with a negative displacement are assumed to be looping code and will end a trace in order to avoid duplication of instructions within the loop.
6. Trace ends at the end of the Mth basic block. (M may be 4, 5, or some other convenient length). This limits the exposure of branches within a trace altering their behavior with respect to branch-taken direction originally predicted.

Trace generation is highly dependent upon the branch prediction success rate. In order to make sure that traces are built using “good” branch prediction, it is necessary to wait for the BHT (containing the branch prediction bits) and the BTAC to “warm up”. This process involves running the code in normal cache mode until it has been determined that the branch prediction has warmed up.

Determination of when the BTAC and BHT are “warmed up” is described in a related patent application filed Oct. 5, 2006 under Ser. No. 11/538,831, entitled “Apparatus and Method for Using Branch Prediction Heuristics for Determination of Trace Formation Readiness”. If the BTAC and BHT are not warmed up, trace formation will not even be attempted. Even after warm up is complete, there are several constraints that branch prediction places on trace formation:
1. Terminate formation of a trace if a BTAC entry is not valid for a branch in the current basic block. If a branch does not have an updated BTAC entry then this is the first time the path has been encountered and there is insufficient knowledge to predict its path.
2. Terminate trace formation on a weakly predicted branch. It is assumed that branch prediction has not been warmed up. The trace may or may not be saved within the trace cache, depending on the position within the trace entry of the weakly predicted branch.

Traces must be made from basic blocks (code segments) containing the same protection attributes as each other. This is required since the address of code segments is not maintained in the trace cache (only the starting address and the next address at the end). Therefore, the translation process occurs on all code segments when the trace line is built but only on the starting address of the trace line when the trace is accessed from the cache.
1. End trace formation when code has entered into a page with different protection attributes.
2. Instructions: Isync, rfi, sc, mtmsr, trap or ISI will end a trace.
3. These instructions are synchronizing type instructions that change the translation state of the operating system. Therefore the page attributes after the instruction will be different than before.

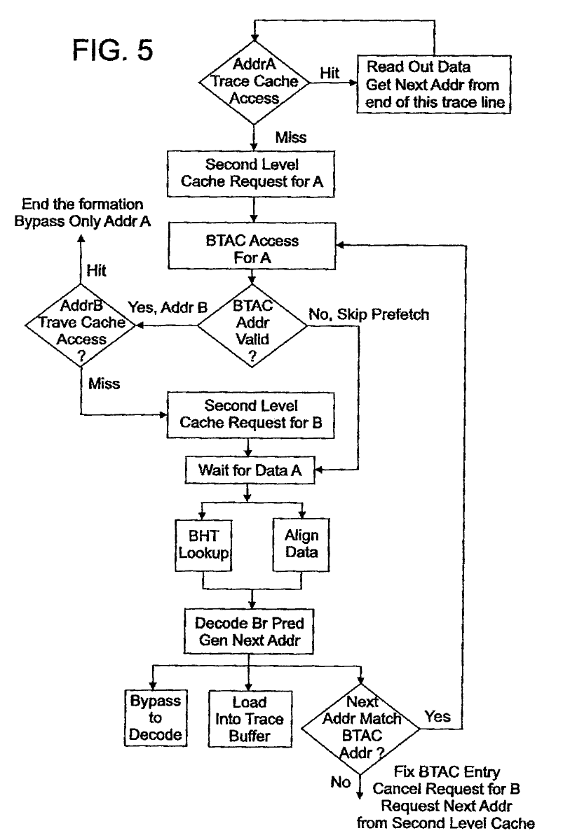

FIG. 5 is a flow diagram that illustrates the steps required for trace cache access and forming new entries into the trace cache. The process starts when a given address (AddrA) is presented to the trace cache as a read access. If the access is a HIT (meaning data is resident in the cache) then the data is read out of the cache and the instructions are passed down the pipeline while the next fetch address is used to re-access the trace cache.

If the cache access is a Miss (meaning data is NOT resident in the cache) then a request is immediately sent to the second level cache for AddrA. AddrA is also used to access the BTAC to obtain the next address to fetch (AddrB). If the BTAC has a valid match for AddrA then AddrB is used to access the trace cache and then sent to the second level cache (if a trace cache miss). If there is not a valid BTAC match for AddrA then AddrB is not known and therefore must wait for AddrA data to compute AddrB.

Once data arrives from the second level cache for AddrA then the BHT is accessed for branch prediction and the instructions are aligned for adding to the current trace. All branches are then predicted taken/not taken and the next address is determined from the first predicted taken branch. This address is compared against the previous address that was read from the BTAC. If they match then the BTAC is accessed again for the next fetch address. If the addresses do not match then the BTAC entry needs to be corrected and any outstanding second level requests must be canceled.

Instructions from the second level cache are then bypassed around the trace cache and are also appended to the trace buffer to continue forming the current trace. Once the trace buffer is full (or achieves one of the trace termination criteria) it is written into the trace cache.

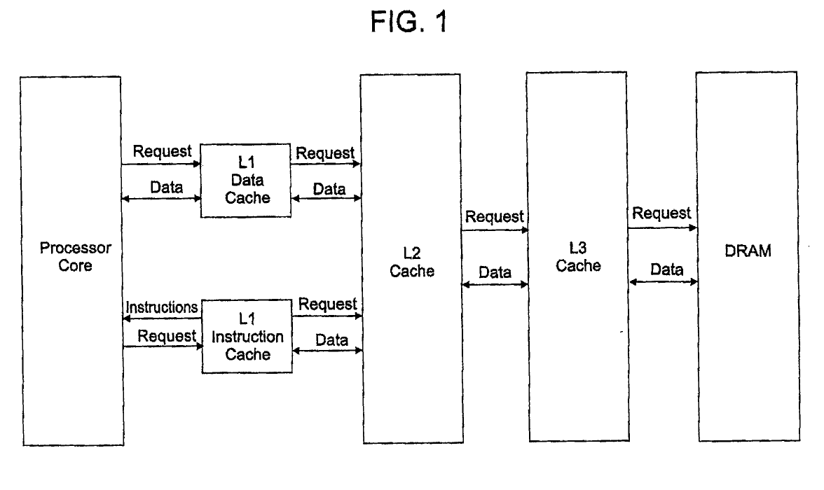

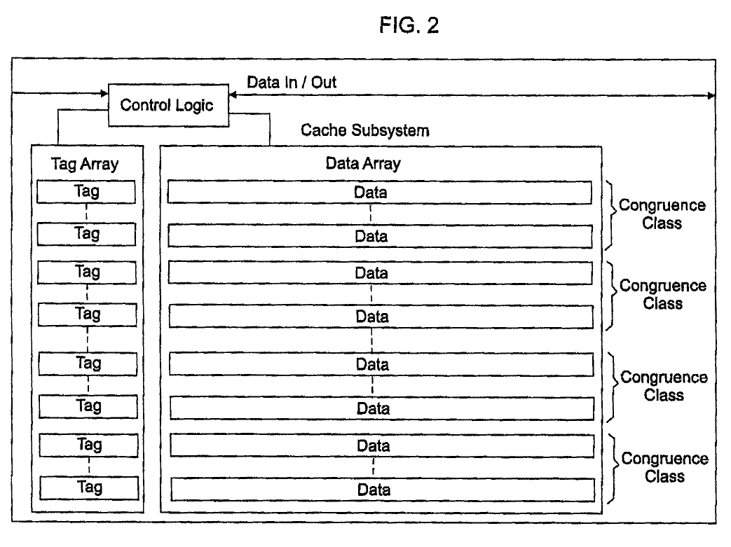

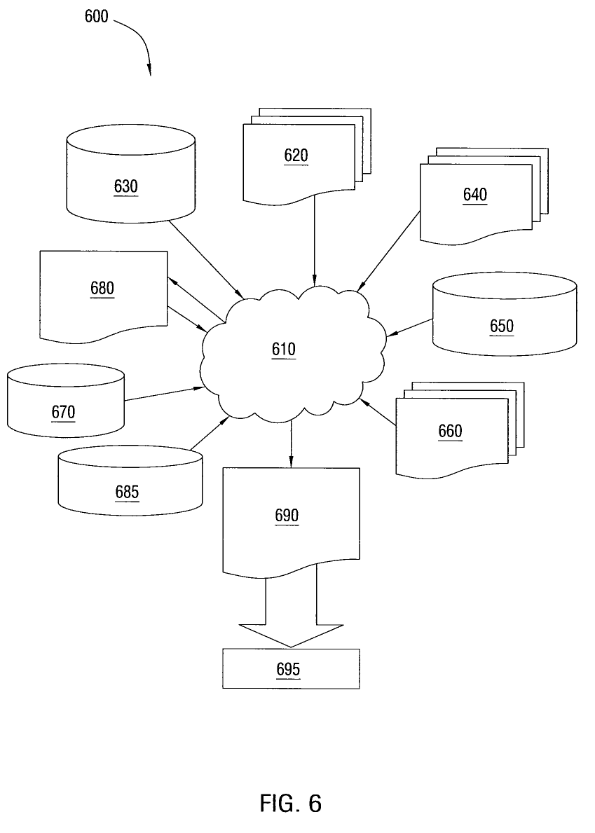

FIG. 6 shows a block diagram of an exemplary design flow 600 used for example, in semiconductor design, manufacturing, and/or test. Design flow 600 may vary depending on the type of IC being designed. For example, a design flow 600 for building an application specific IC (ASIC) may differ from a design flow 600 for designing a standard component. Design structure 620 is preferably an input to a design process 610 and may come from an IP provider, a core developer, or other design company or may be generated by the operator of the design flow, or from other sources. Design structure 620 comprises the circuits described above and shown in FIGS. 1-4 in the form of schematics or HDL, a hardware-description language (e.g., Verilog, VHDL, C, etc.). Design structure 620 may be contained on one or more machine readable medium. For example, design structure 620 may be a text file or a graphical representation of a circuit as described above and shown in FIGS. 1-4. Design process 610 preferably synthesizes (or translates) the circuits described above and shown in FIGS. 1-4 into a netlist 680, where netlist 680 is, for example, a list of wires, transistors, logic gates, control circuits, I/O, models, etc. that describes the connections to other elements and circuits in an integrated circuit design and recorded on at least one of machine readable medium. For example, the medium may be a storage medium such as a CD, a compact flash, other flash memory, or a hard-disk drive. The medium may also be a packet of data to be sent via the Internet, or other networking suitable means. The synthesis may be an iterative process in which netlist 680 is resynthesized one or more times depending on design specifications and parameters for the circuit.

Design process 610 may include using a variety of inputs; for example, inputs from library elements 630 which may house a set of commonly used elements, circuits, and devices, including models, layouts, and symbolic representations, for a given manufacturing technology (e.g., different technology nodes, 32 nm, 45 nm, 90 nm, etc.), design specifications 640, characterization data 650, verification data 660, design rules 670, and test data files 685 (which may include test patterns and other testing information). Design process 610 may further include, for example, standard circuit design processes such as timing analysis, verification, design rule checking, place and route operations, etc. One of ordinary skill in the art of integrated circuit design can appreciate the extent of possible electronic design automation tools and applications used in design process 610 without deviating from the scope and spirit of the invention. The design structure of the invention is not limited to any specific design flow.

Design process 610 preferably translates a circuit as described above and shown in FIGS. 1-4, along with any additional integrated circuit design or data (if applicable), into a second design structure 690. Design structure 690 resides on a storage medium in a data format used for the exchange of layout data of integrated circuits (e.g. information stored in a GDSII (GDS2), GL1, OASIS, or any other suitable format for storing such design structures). Design structure 690 may comprise information such as, for example, test data files, design content files, manufacturing data, layout parameters, wires, levels of metal, vias, shapes, data for routing through the manufacturing line, and any other data required by a semiconductor manufacturer to produce a circuit as described above and shown in FIGS. 1-4. Design structure 690 may then proceed to a stage 695 where, for example, design structure 690: proceeds to tape-out, is released to manufacturing, is released to a mask house, is sent to another design house, is sent back to the customer, etc.

In the drawings and specifications there has been set forth a preferred embodiment of the invention and, although specific terms are used, the description thus given uses terminology in a generic and descriptive sense only and not for purposes of limitation.

What is claimed is:

1. A design structure embodied in a machine readable storage medium for at least one of designing, manufacturing, and testing a design, the design structure comprising:
an apparatus comprising:
a computer system central processor;
layered memory operatively coupled to said central processor and accessible thereby, said layered memory having a level one cache storing in interchangeable locations both conventional cache lines of sequential instructions and trace cache lines of predicted branch instructions; and
circuitry operatively connected to said layered memory and generating data to be stored in said level one cache, said circuitry distinguishing between conventional cache lines and trace cache lines.

2. The design structure according to claim 1, wherein said circuitry comprises a trace generating buffer in which trace cache lines are assembled from instructions derived from a higher level cache.

3. The design structure according to claim 2, wherein said circuitry comprises a steering circuit directing conventional cache lines derived from a higher level cache to bypass said trace generating buffer and pass directly to storage in said level one cache and execution.

4. The design structure according to claim 1, wherein said circuitry comprises a decode/branch predict component through which instructions pass in moving from a higher level cache toward the level one cache.

5. The design structure according to claim 1, wherein said circuitry executes at least one of a plurality of rules defining circumstances under which a trace line to be cached is terminated.

6. The design structure according to claim 1, wherein said circuitry executes a plurality of rules, each of which defines a circumstance under which a trace line to be cached is terminated.

7. The design structure according to claim 1, wherein said circuitry executes at least one selected one of a plurality of rules defining circumstances under which a trace line to be cached is terminated, the rules stating:
1. Trace lines have a maximum of N instructions determined by the physical length of each line in the cache;
2. If at the end of a basic block, the trace is filled within a predetermined number of instructions from the end of the trace buffer, the construction of the trace line is terminated;
3. A trace is terminated on data-dependent branch targets (branch to link, branch to count) since the branch-to address is not accurately predictable;
4. A trace is terminated on a bdnz (and similar type) instruction used to form a loop, avoiding duplication of instructions within a loop;
5. Branches with a negative displacement are assumed to be looping code and end a trace in order to avoid duplication of instructions within the loop; and
6. A trace ends at the end of the Mth basic block. (M may be 4, 5, or some other convenient length), limiting the exposure of branches within a trace altering their behavior with respect to branch-taken direction originally predicted.

8. The design structure of claim 1, wherein the design structure comprises a netlist, which describes the apparatus.

9. The design structure of claim 1, wherein the design structure resides on the machine readable storage medium as a data format used for the exchange of layout data of integrated circuits.
